(19) United States
(12) Patent Application Publication
(10) Pub. No.: US 2007/0183941 A1
(43) Pub. Date: Aug. 9, 2007

(54) Air cleaner for ozone and Volatile Organic Compound (VOC) removal

(75) Inventor: John Relman Bohlen, Gulfport, MS (US)

Correspondence Address: THE OLLILA LAW GROUP LLC, 2060 BROADWAY, SUITE 300, BOULDER, CO, 80302, US

(73) Assignee: Oreck Holdings, LLC

(21) Appl. No.: 11/349,011

(22) Filed: Feb. 7, 2006

(51) Int. Cl. B01D 50/00

(52) U.S. Cl. 422/177

(57) ABSTRACT

An air cleaner for ozone and Volatile Organic Compound (VOC) removal is provided according to an embodiment of the invention. The air cleaner includes an air channel in the air cleaner, an air moving unit located in the air channel and configured to create an airflow, and a combination ozone/VOC removing element located in the air channel. The combination ozone/VOC removing element substantially removes ozone and VOCs in the airflow.

### TECHNICAL FIELD

The present invention relates to an air cleaner, and more particularly, to an air cleaner for ozone and Volatile Organic Compound (VOC) removal.

### BACKGROUND OF THE INVENTION

Air cleaners are widely used in home and office settings for cleaning the air. An air cleaner can filter the air in order to remove airborne contaminants. An air cleaner can therefore include any type of mechanical filter element comprising a mesh, a weave, a foam, etc.

In addition to filtering particles out of the air, an air cleaner can include an air ionizer, such as an electrostatic precipitator with a corona field or pre-ionizer element, which ionizes airflow passing through the air cleaner. The ionization transforms stable (O₂) molecules in the air into ozone molecules (O₃). Subsequently, the third oxygen atoms of the ozone molecules enter into destructive reactions with contaminants in the vicinity by oxidizing compounds they come into contact with. The oxidation can add oxygen molecules to these contacted compounds during the oxidation reaction.

Ozone is a powerful oxidizer because it is not a stable molecule. Ozone molecules spontaneously return to a stable, molecular state by releasing their third oxygen atoms. However, the spontaneous breakdown of ozone does not occur immediately, and substantial amounts of ozone can linger in the airstreams for some time.

One of the great advantages of ozone is that it is not selective in the reactions it initiates. It neutralizes harmful VOCs by oxidizing them. Ozone destroys pathogens (microorganisms), either by reducing or destroying them or by cell lysing or oxidation. Another beneficial effect of ozone is that ozone treatment of the air can remove some troublesome odors.

However, the use of ozone for air cleaning has drawbacks. Being a highly unstable and reactive form of oxygen, the ozone also reacts with living matter. Relatively low concentrations of ozone are known to cause headaches, nausea, and irritation of mucous membranes. Higher levels of ozone cause progressively more severe respiratory problems. As a result, ozone in higher concentrations can be troublesome to humans and animals. Consequently, ozone should desirably be removed from the air after generation.

Another category of indoor air pollutants are VOCs. VOCs are organic chemical compounds that have high enough vapor pressures under normal conditions to significantly vaporize and enter the atmosphere. A wide range of carbon-based molecules, such as aldehydes, ketones, and hydrocarbons are all considered to be VOCs. The term may refer both to well-characterized organic compounds and to mixtures of variable composition. Most often the VOC definition that is used is the definition generated by the United States Environmental Protection Agency (EPA) (see 40 C.F.R. 51.100(s)).

The EPA has found that the concentrations of VOCs in indoor air are commonly 2 to 5 times greater than the concentrations found in outdoor air. During certain activities, indoor levels of VOCs may reach 1,000 times that of the outside air. VOCs may contribute to sick building syndrome.

There are many common sources of VOCs in a typical home. VOCs are often used in paint, plastics, and cosmetics. Household products that are VOC sources include paints, paint strippers and other solvents, wood preservatives, aerosol sprays, cleansers and disinfectants, moth repellents, air fresheners, stored fuels, automotive products, hobby supplies, and dry-cleaning products and dry-cleaned clothing articles.

The health effects of VOCs include eye, nose, and throat irritation, headaches, loss of coordination, nausea, and damage to the liver, kidneys, and central nervous system. In addition, some VOCs are knows to cause cancer in animals and are suspected or known to cause cancer in humans.

In the prior art, air cleaner devices, such as room air cleaner or filter devices, typically include multiple filter elements. These multiple filter element prior art air cleaners can include a mechanical filter element, a separate ozone filter element, and a VOC filter element. These multiple elements lead to larger air cleaners, more difficulty and time required in installation and replacement, less frequent replacement, and higher cost.

### SUMMARY OF THE INVENTION

An air cleaner for ozone and Volatile Organic Compound (VOC) removal is provided according to an embodiment of the invention. The air cleaner comprises an air channel in the air cleaner, an air moving unit located in the air channel and configured to create an airflow, and a combination ozone/VOC removing element located in the air channel. The combination ozone/VOC removing element substantially removes ozone and VOCs in the airflow.

An air cleaner for ozone and VOC removal is provided according to an embodiment of the invention. The air cleaner comprises an air channel in the air cleaner, an air moving unit located in the air channel and configured to create an airflow, and a combination ozone/VOC removing element located in the airflow. The combination ozone/VOC removing element substantially removes ozone and VOCs in the airflow. The combination ozone/VOC removing element comprises a substrate located in the air channel, an ozone catalyzing material formed on the substrate, and a VOC catalyzing material formed on the substrate.

An ozone and VOC removal method for an air cleaner is provided according to an embodiment of the invention. The method comprises providing an air channel in the air cleaner, providing an air moving unit located in the air channel and configured to create an airflow, and providing a combination ozone/VOC removing element located in the air channel. The combination ozone/VOC removing element substantially removes ozone and VOCs in the airflow.

### BRIEF DESCRIPTION OF THE DRAWINGS

The same reference number represents the same element on all drawings. It should be noted that the drawings are not necessarily to scale.

FIG. 1 shows an air cleaner according to an embodiment of the invention.

FIG. 2 shows the combo element according to an embodiment of the invention.

FIG. 3 shows a combo filter according to an embodiment of the invention.

### DETAILED DESCRIPTION OF THE INVENTION

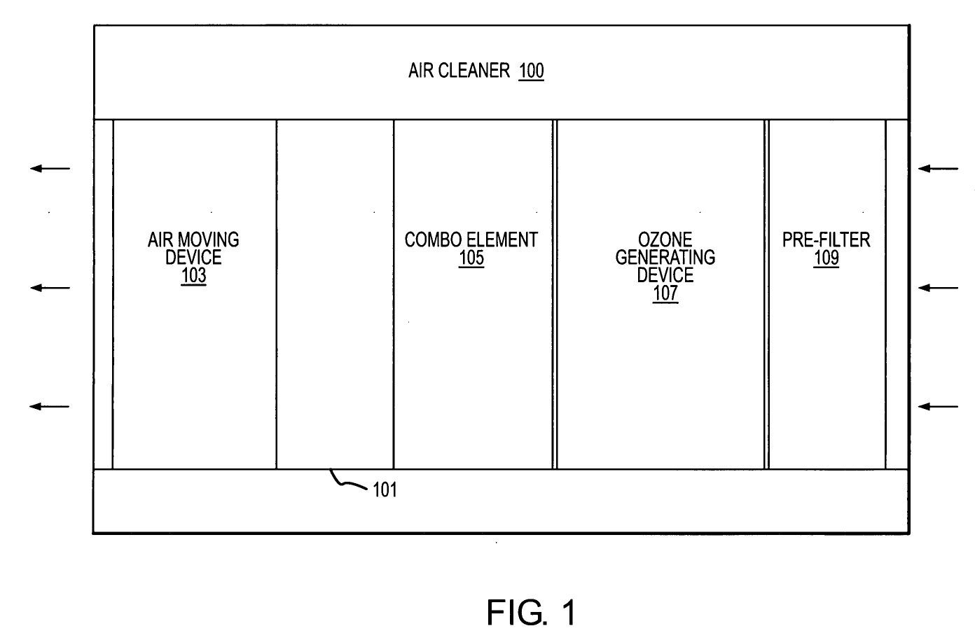

FIGS. 1-3 and the following descriptions depict specific embodiments to teach those skilled in the art how to make and use the best mode of the invention. For the purpose of teaching inventive principles, some conventional aspects have been simplified or omitted. Those skilled in the art will appreciate variations from these embodiments that fall within the scope of the invention. Those skilled in the art will also appreciate that the features described below can be combined in various ways to form multiple variations of the invention. As a result, the invention is not limited to the specific embodiments described below, but only by the claims and their equivalents.

FIG. 1 shows an air cleaner 100 according to an embodiment of the invention. The air cleaner 100 in includes an air channel 101, an air moving device 103 located in the air channel 101, a combination ozone and Volatile Organic Compound (VOC) removing element 105 (hereinafter a combo element 105), an ozone generating device 107, and a pre-filter 109. In addition, the combo element 105 can remove odors from the airflow.

The air cleaner 100 can comprise any configuration, such as substantially rectangular, substantially round, a tower, etc. The air cleaner 100 can comprise a floor air cleaner model, a table top air cleaner model, a portable or personal air cleaner model, etc.

The air moving device 103 generates airflow in the air channel 101 and through the air cleaner 100 (see arrows). The air moving device 103 can comprise a motor that spins an impeller. The impeller in one embodiment comprises a squirrel cage fan impeller. The air channel 101 in the embodiment shown is substantially horizontal. However, it should be understood that the air channel 101 can be positioned in any orientation within the air cleaner 100.

The ozone generating device 107 can comprise any source of ozone. For example, the ozone generating device 107 in one embodiment comprises an air ionizer that is designed to generate significant levels of ozone molecules in order to kill living material in the air and to decompose unwanted or unhealthy material in the air. It is desirable to remove this ozone from the airflow of the air cleaner 100. In another embodiment, the ozone generating device 107 comprises an electrostatic precipitator that is designed to electrostatically charge dirt and debris particles in the airflow and then collects the charged particles on one or more collection plates. An electrostatic precipitator can produce relatively small amounts of ozone as a by-product. In yet another embodiment, the ozone. generating device 107 comprises an ultraviolet (UV) light source that generates ozone.

The pre-filter 109 comprises a filter element that removes dirt and debris from the airflow entering the air cleaner 100. The pre-filter can comprise any manner of mesh, foam, fibers, etc., that block particles of dirt and debris from entering the air cleaner 100.

The combo element 105 is located in the air channel 101 and therefore the airflow passes through the ozone generating device 107 and through the combo element 105. After the ozone has reacted with contaminants in the airflow, the resulting ozone and other contaminants in the airflow are removed by the combo element 105.

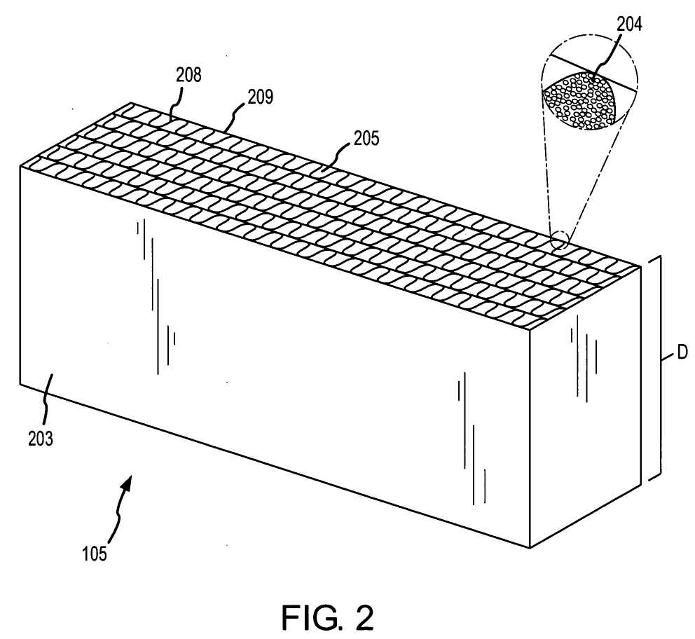

The combo element 105 comprises a substrate (such as a three-dimensional matrix, for example) that includes an ozone catalyst layer deposited on the substrate (see FIG. 2 and the accompanying discussion below). The combo element 105 therefore removes a significant amount of the ozone that is generated by the ozone generating device 107. In addition, the combo element 105 also includes a VOC removing layer deposited on the substrate. As a result, the combo element 105 removes VOCs in the airflow by a process of catalyzation. The combo element 105 further removes odors from the airflow. The odor removal can be by catalyzation or adsorption. Because the combo element 105 substantially removes ozone, VOCs, and odors from the airflow, the air cleaner 100 removes a very high proportion of contaminants that can cause odors, irritation, or health problems. The air cleaner 100 therefore provides the sterilizing and sanitizing benefits of ozone, but without the negative implications of human exposure to unacceptable levels of ozone. In addition, VOCs are substantially removed from the air, removing the health risks that they represent.

In one embodiment, the combo element 105 extends substantially fully across the air channel 101, and as a result the airflow cannot pass through the air channel 101 without passing through the combo element 105. The combo element 105, because it extends fully across the air channel 101, does not allow a portion of airflow to exit without scrubbing.

FIG. 2 shows the combo element 105 according to an embodiment of the invention. The combo element 105 comprises a substrate 203 and a removal material 204 formed on the substrate 203 (see insert). The removal material 204 can remove ozone, VOCs, and odors from the airflow. The removal material 204 can comprise two or more removal components that are coated onto or impregnated in the substrate 203. The removal material 204 can include a first removal component for removing ozone from the airflow and a second removal component for removing VOCs. In addition, the removal material 204 can include a third removal component for removing odors. The first and second removal components can comprise catalytic compounds that transform the ozone and the VOCs that pass through the combo element 105. The third removal component can comprise either a catalyst material or an adsorption material. Advantageously, catalyst materials do not collect contaminants and therefore do not lose effectiveness over time.

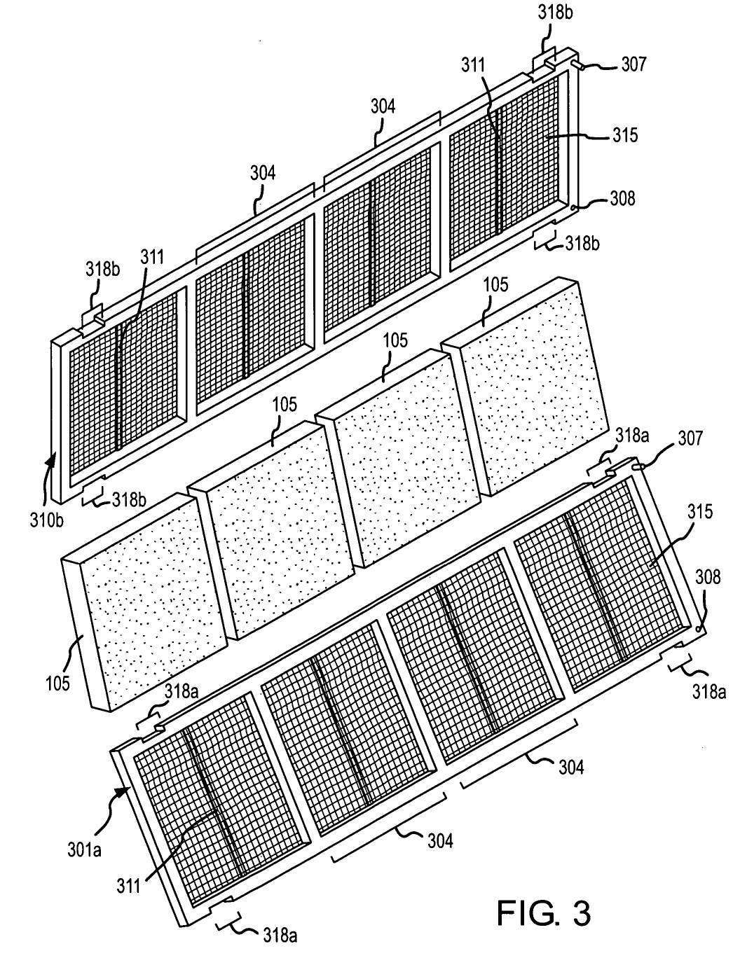

The substrate 203 can be assembled into a frame 301 (see FIG. 3) that fits to and supports the substrate 203. The substrate 203 includes a depth D. The depth D can be chosen according to various factors, including the available space in the air cleaner 100, the velocity of the airflow, the desired back pressure or pressure drop across the combo element 105, the needed surface area of the substrate 203, etc.

The substrate 203 comprises a plurality of substantially depth-wise air passages 205. The air passages 205 can be substantially aligned with the airflow, as previously discussed. Alternatively, the substrate 203 can act as a flow straightener and can provide a substantially smooth and aligned airflow into the air moving device 103. The air passages 205 can be formed in various ways, such as by crimping or forming, bonding, deposition or forming of fibers, aeration or heating of materials, stretching, etc. In the embodiment shown, the air passages 205 are substantially straight and the cross-sectional shape of an air channel 205 is substantially regular. Alternatively, the air passages 205 can be formed in irregular cross-sectional shapes and do not have to be co-linear and aligned with the airflow.

The air passages 205 can comprise any cross-sectional size. For example, where the air passages 205 are relatively large, the substrate 203 can comprise 80 cells per square inch or less. Such a large cell size will result in a relatively low back pressure presented by the substrate 203. In another example, where the air passages 205 are relatively small, the substrate 303 can comprise more than 80 cells per square inch. Such a small cell size will result in a higher back pressure but will provide more reactive surface area and therefore more efficient ozone/VOC decomposition. However, it should be understood that the substrate 203 according to the invention beneficially provides a much lower back pressure than generated by typical foam or pleated style filters.

In the embodiment shown, the air passages 205 are formed by series of substantially serpentine sheets 208 interspersed with substantially planar divider sheets 209. The sheets 208 and 209 can comprise any suitable materials. The substrate 203 can comprise any number of serpentine sheets 208 and planar divider sheets 209, wherein the substrate 203 can be formed to a desired shape and size. However, it should be understood that the air passages 205 can include other cross-sectional shapes, including octagonal, hexagonal, circular, irregular, etc.

In one embodiment, the substrate 203 is formed of a metal matrix, such as an aluminum matrix, for example. The aluminum matrix allows some compression, wherein the aluminum matrix can accommodate some shaping. In another embodiment, the substrate 203 is formed of a ceramic/paper matrix. The ceramic/paper matrix advantageously can be impregnated with a higher concentration of removal components than a metal matrix.

The ozone decomposing material 204 interacts with and decomposes ozone that impinges on the combo element 105. Because the airflow must flow through the combo element 105, the ozone decomposition is substantially complete and uniform.

In one embodiment, the removal material 204 includes a metal oxide material deposited on the substrate 203. Ozone reacts with the metal oxide and decomposes. In one embodiment, the ozone decomposing material 204 comprises manganese oxide (MnO₂). However, it should be understood that the ozone decomposing material 204 can comprise any manner of suitable metal oxide.

The combo element 105 can comprise a HONEYCLE material, available from NCI Mfg., Inc., Scottsboro, Ala. The combo element 105 can comprise a NHC material, available from Nikki-Universal Co., Ltd., Tokyo, Japan.

FIG. 3 shows a combo filter 300 according to an embodiment of the invention. The combo filter 300 includes a frame 301 and a plurality of combo elements 105 held within the frame 301. In the embodiment shown, four combo elements 205 are included in the combo filter 300. This four section embodiment advantageously allows the combo filter 300 to flex during shipping, handling, and installation, which reduces the risk of damaging the filter media. However, it should be understood that any number of combo elements 205 may be used. The number of combo elements 205 in some embodiments may depend on the desired dimensions of the combo filter 300.

The frame 301 can comprise frame portions 301a and 301b that join to form the frame 301 and to hold the plurality of combo elements 105. The frame 301 can be formed of a flame resistant material, such as polypropylene, for example. The frame portions 301a and 301b include projections 307 and corresponding apertures 308. The projections 307 and the apertures 308 may affix to each other in some manner of friction or snap fit. In one embodiment, the frame portions 301a and 301b are identical.

The frame portions 301a and 301b can include a plurality of bays 304 that receive combo elements 205. Each bay 304 is of a size to receive and accommodate a combo element 205. A combo element 205 in one embodiment may fit tightly in a bay 304. Alternatively, a bay 304 may loosely receive and hold a combo element 205 in the assembled frame 301.

Each bay 304 can include a cross-support 311. A cross-support 311 can help to retain a combo element 205 in the bay 304.

Each bay 304 can include a mesh panel 315. A mesh panel 315 is affixed in the bay 304. The mesh panel 315 can be molded into the frame portion 301, for example. A mesh panel 315 can comprise a nylon mesh. The mesh panel 315 can serve as a barrier between the filter media and the user during handling. The mesh panel 315 therefore reduces the transfer of catalyst from the matrix to the user's hands. The mesh panel 315 may also catch and contain any loose particles which may break off of the substrate/matrix if damaged during shipping and handling.

A frame portion 301a or 301b can include one or more depressions 318. In an embodiment where the frame portions 301a and 301b are identical, corresponding depressions 318a and 318b will substantially align to create a continuous depression 318 in the frame 310. A depression 318 can be used for handing the combo filter 300 during manufacturing. A depression can be used for aligning and retaining the combo filter 300 in the air cleaner 100.

The air cleaner according the invention can be implemented according to any of the embodiments in order to obtain several advantages, if desired. The invention provides an air cleaner that uses ozone to kill living organisms in an airflow. The invention provides an air cleaner that uses ozone to neutralize airborne contaminants, including VOCs, for example. The invention provides an air cleaner that uses ozone to remove odors from an airflow. The invention provides an air cleaner that removes ozone from an airflow. The invention provides an air cleaner that removes VOCs from an airflow.

The invention provides an air cleaner that includes a single removal element that simultaneously removes both ozone and VOCs from the airflow. The invention provides an air cleaner that includes a single removal element that simultaneously removes ozone, VOCs, and odors from the airflow. The invention uses a catalyzing compound for removing ozone. The invention uses a catalyzing compound for removing VOCs.

Unlike the prior art, the air cleaner according to the invention does not employ adsorption for removing ozone or VOCs. As a result, the air cleaner according to the invention does not have the drawbacks in the prior art, wherein a prior art adsorption filter can become filled up and therefore can lose effectiveness over time.

What is claimed is:

1. An air cleaner for ozone and Volatile Organic Compound (VOC) removal, the air cleaner comprising:
an air channel in the air cleaner;
an air moving unit located in the air channel and configured to create an airflow; and
a combination ozone/VOC removing element located in the air channel, with the combination ozone/VOC removing element substantially removing ozone and VOCs in the airflow.

2. The air cleaner of claim 1, with the combination ozone/VOC removing element further removing odors in the airflow.

3. The air cleaner of claim 1, with the combination ozone/VOC removing element extending substantially fully across the air channel.

4. The air cleaner of claim 1, with the combination ozone/VOC removing element comprising a plurality of air passages that are substantially aligned with the airflow.

5. The air cleaner of claim 1, with the combination ozone/VOC removing element further comprising a substrate including a depth and a plurality of substantially depth-wise air passages formed through the substrate.

6. The air cleaner of claim 5, with the substrate comprising an airflow straightening matrix.

7. The air cleaner of claim 5, with the substrate comprising a ceramic paper matrix substrate.

8. The air cleaner of claim 5, with the substrate comprising an aluminum matrix substrate.

9. The air cleaner of claim 5, with the combination ozone/VOC removing element further comprising:
an ozone catalyzing material formed on the substrate; and
a VOC catalyzing material formed on the substrate.

10. The air cleaner of claim 5, with the combination ozone/VOC removing element further comprising:
an odor removing material formed on the substrate;
an ozone catalyzing material formed on the substrate; and
a VOC catalyzing material formed on the substrate.

11. The air cleaner of claim 5, with the substrate comprising:
a plurality of spaced-apart, substantially planar divider sheets; and
a plurality of substantially serpentine sheets interspersed between the plurality of divider sheets.

12. The air cleaner of claim 1, further comprising a frame that surrounds and holds one or more combination ozone/VOC removing elements.

13. The air cleaner of claim 1, further comprising:
at least a first frame portion and a second frame portion, with the first frame portion and the second frame portion assembling to form a frame that surrounds and holds one or more combination ozone/VOC removing elements;
one or more corresponding bays formed in each of the first frame portion and the second frame portion, with a bay receiving the one or more combination ozone/VOC removing elements; and
one or more corresponding mesh panels extending across the one or more bays.

14. An air cleaner for ozone and Volatile Organic Compound (VOC) removal, the air cleaner comprising:
an air channel in the air cleaner;
an air moving unit located in the air channel and configured to create an airflow; and
a combination ozone/Volatile Organic Compound (VOC) removing element located in the airflow, with the combination ozone/VOC removing element substantially removing ozone and VOCs in the airflow and with the combination ozone/VOC removing element comprising:
a substrate located in the air channel;
an ozone catalyzing material formed on the substrate; and
a VOC catalyzing material formed on the substrate.

15. The air cleaner of claim 14, with the combination ozone/VOC removing element further removing odors in the airflow.

16. The air cleaner of claim 14, with the combination ozone/VOC removing element extending substantially fully across the air channel.

17. The air cleaner of claim 14, with the substrate comprising a plurality of air passages that are substantially aligned with the airflow.

18. The air cleaner of claim 14, with the substrate including a depth and a plurality of substantially depth-wise air passages formed through the substrate.

19. The air cleaner of claim 14, with the substrate comprising an airflow straightening matrix.

20. The air cleaner of claim 14, with the substrate comprising a ceramic paper matrix substrate.

21. The air cleaner of claim 14, with the substrate comprising an aluminum matrix substrate.

22. The air cleaner of claim 14, with the substrate comprising:
a plurality of spaced-apart, substantially planar divider sheets; and
a plurality of substantially serpentine sheets interspersed between the plurality of divider sheets.

23. The air cleaner of claim 14, further comprising a frame that surrounds and holds one or more combination ozone/VOC removing elements.

24. The air cleaner of claim 14, further comprising:
at least a first frame portion and a second frame portion, with the first frame portion and the second frame portion assembling to form a frame that surrounds and holds one or more combination ozone/VOC removing elements;
one or more corresponding bays formed in each of the first frame portion and the second frame portion, with a bay receiving the one or more combination ozone/VOC removing elements; and
one or more corresponding mesh panels extending across the one or more bays.

25. An ozone and Volatile Organic Compound (VOC) removal method for an air cleaner, the method comprising:
providing an air channel in the air cleaner;
providing an air moving unit located in the air channel and configured to create an airflow; and
providing a combination ozone/VOC removing element located in the air channel, with the combination ozone/VOC removing element substantially removing ozone and VOCs in the airflow.

26. The method of claim 25, with the combination ozone/VOC removing element further removing odors in the airflow.

27. The method of claim 25, with the combination ozone/VOC removing element extending substantially fully across the air channel.

28. The method of claim 25, with the combination ozone/VOC removing element comprising a plurality of air passages that are substantially aligned with the airflow.

29. The method of claim 25, with the combination ozone/VOC removing element further comprising a substrate including a depth and a plurality of substantially depth-wise air passages formed through the substrate.

30. The method of claim 29, with the substrate comprising an airflow straightening matrix.

31. The method of claim 29, with the substrate comprising a ceramic paper matrix substrate.

32. The method of claim 29, with the substrate comprising an aluminum matrix substrate.

33. The method of claim 29, with the combination ozone/VOC removing element further comprising:
an ozone catalyzing material formed on the substrate; and
a VOC catalyzing material formed on the substrate.

34. The method of claim 29, with the combination ozone/VOC removing element further comprising:
an odor removing material formed on the substrate;
an ozone catalyzing material formed on the substrate; and
a VOC catalyzing material formed on the substrate.

35. The method of claim 29, with the substrate comprising:
a plurality of spaced-apart, substantially planar divider sheets; and
a plurality of substantially serpentine sheets interspersed between the plurality of divider sheets.

36. The method of claim 25, further comprising providing a frame that surrounds and holds one or more combination ozone/VOC removing elements.

37. The method of claim 25, further comprising:
providing at least a first frame portion and a second frame portion, with the first frame portion and the second frame portion assembling to form a frame that surrounds and holds one or more combination ozone/VOC removing elements;
providing one or more corresponding bays formed in each of the first frame portion and the second frame portion, with a bay receiving the one or more combination ozone/VOC removing elements; and
providing one or more corresponding mesh panels extending across the one or more bays.
